(19) United States
(12) Patent Application Publication
(10) Pub. No.: US 2005/0026115 A1
(43) Pub. Date: Feb. 3, 2005

(54) Method of inducing bleeding after dental surgery

(76) Inventors: Larry Kincade, Sherwood Park (CA); Richard Bayly, Sherwood Park (CA); Christie Woodruff, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/811,778

(22) Filed: Mar. 29, 2004

(30) Foreign Application Priority Data
Mar. 27, 2003 (CA) 2,423,678

(51) Int. Cl. A61C 17/00; A61C 5/00

(52) U.S. Cl. 433/215; 433/216

(57) ABSTRACT

A method of inducing bleeding after dental surgery involves a single step of flushing a surgical site with gaseous nitric oxide immediately following dental surgery. The nitric oxide is a vasodilator which induces bleeding.

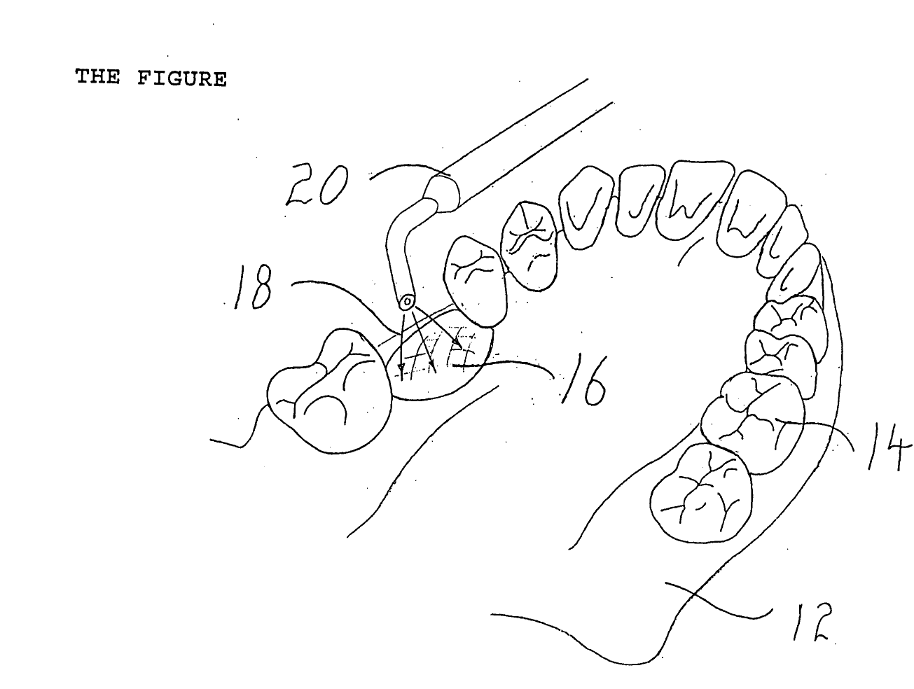

### FIELD OF THE INVENTION

The present invention relates to a method of inducing bleeding after dental surgery.

### BACKGROUND OF THE INVENTION

The human mouth serves as a host for micro-organisms. Dental surgery can result in oral micro-organisms being introduced into the blood stream. Within a short time after introduction, such organisms are circulated to the heart lungs and peripheral blood capillary system.

In order to prevent oral micro-organisms from being introduced into the blood stream, it has become standard procedure to induce bleeding after dental surgery. This is presently done mechanically with a sharp instrument. The mechanical damage inflicted unavoidably prolongs the time it takes for the patient to recover.

### SUMMARY OF THE INVENTION

What is required is a method of inducing bleeding after dental surgery which is less harmful to the patient.

According to the present invention there is provided a method of inducing bleeding after dental surgery which involves a single step of flushing a surgical site with gaseous nitric oxide immediately following dental surgery. The nitric oxide is a vasodilator which induces bleeding.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

THE FIGURE is a perspective view of the preferred method of inducing bleeding after dental surgery.

### DETAILED DESCRIPTION OF THE PREFERRED EMBODIMENT

The preferred method will now be described with reference to THE FIGURE.

In the illustrated embodiment, a jaw 12 with teeth 14 is provided. A surgical site 16 in the manner of a typical extraction is flushed with nitric oxide 18 administered from a dental appliance 20. It will be appreciated that the preferred method may be used in other oral surgeries or sites and other physiological configurations.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

1. A method of inducing bleeding after dental surgery, comprising the step of:
flushing a surgical site with gaseous nitric oxide immediately following dental surgery, the nitric oxide being a vasodilator which induces bleeding.
